(19) United States
(12) Patent Application Publication
(10) Pub. No.: US 2004/0124171 A1
(43) Pub. Date: Jul. 1, 2004

(54) [BUMP-FORMING PROCESS]

(76) Inventor: Shyh-Ing Wu, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,345

(22) Filed: Sep. 24, 2003

(30) Foreign Application Priority Data
Dec. 30, 2002 (TW) 91137815

(51) Int. Cl. B44C 1/22

(52) U.S. Cl. 216/11

(57) ABSTRACT

A bump-forming process is provided. An adhesion layer is formed on an active surface of a wafer. A barrier layer and a wettable layer are sequentially formed over the adhesion layer. A portion of the wettable layer and a portion of the barrier layer are removed and then a patterned mask layer is formed over the adhesion layer. The mask layer has a plurality of openings that at least exposes the wettable layer. A printing process is performed to deposit solder paste into the openings. Thereafter, a reflow process is carried out so that the solder paste inside the openings is transformed into bumps. The mask layer is removed, followed by removing the adhesion layer outside the residual wettable layer and the residual barrier layer.

### CROSS REFERENCE TO RELATED APPLICATIONS

This application claims the priority benefit of Taiwan application serial no. 91137815, filed Dec. 30, 2002.

### BACKGROUND OF INVENTION

1. Field of Invention

The present invention relates to a bump-forming process. More particularly, the present invention relates to a bump-forming process that produces reliable bumps and ensures integrity of overlying polymer passivation layer.

2. Description of Related Art

Flip-chip bonding is a technology for physically and electrically joining a die and a substrate or a printed circuit board (PCB). The process includes positioning a plurality of bonding pads in the form of an area array on the active surface of a die and then forming a bump on each bonding pad. Afterwards, the die is flipped over and the bumps are aligned with corresponding mounting pads on the substrate or PCB. Finally, the die and the substrate or PCB are joined together through the bumps. The flip-chip technique can be applied to the fabrication of high-pin-count chip packages. Furthermore, flip-chip packages demand a smaller package area and have a shorter overall transmission pathway. Consequently, flip-chip bonding technique is commonly applied to the fabrication of chip packages.

To facilitate the bonding of a die with a substrate or a PCB using the flip-chip technique, bumps are normally formed on the bonding pads on the active surface of the die prior to bonding. For example, in a conventional bump-forming process, a stencil or a photosensitive film having a plurality of openings that exposes the bonding pads is formed over the active surface of the die (or wafer) to serve as a mask. Thereafter, a plating or a printing process is carried out to spread solder material into the openings above the bonding pads. The stencil or the photosensitive film is removed to expose the solder layer over various bonding pads. After a reflow process, the solder layers solidify into a bump having a spherical profile on the bonding pads.

FIGS. 1A to 1F are magnified cross-sectional views of the bump sections in the wafer showing the steps for producing bumps according to a conventional method. First, as shown in FIG. 1A, a wafer 100 having an active surface 102, a plurality of bonding pads 104 (only one is shown), a passivation layer 106 and a polymer layer 108 is provided. The plurality of bonding pads 104 are disposed on the active surface 102, while the passivation layer 106 and the polymer layer 108 are sequentially positioned on the active surface 102 with openings 110 that expose the bonding pads 104.

As shown in FIG. 1B, an under-bump-metallurgy (UBM) layer 112 is formed over the active surface 102 of the wafer 100. The UBM layer 112 includes an adhesion layer 114, a barrier layer 116 on the adhesion layer 114 and a wettable layer 118 on the adhesion layer 114.

As shown in FIG. 1C, photolithographic and etching processes are conducted to remove a portion of the under-bump-metallurgy layer 112 to form an under-ball-metallurgy layer 112a and expose the polymer layer 108. The under-bump-metallurgy layer 112a is disposed at least within the opening 110.

As shown in FIG. 1D, a patterned mask layer 120 is formed on the active surface 102. The patterned mask layer 120 has a plurality of openings (only one is shown) that exposes the under-bump-metallurgy layer 112a over the bonding pad 104.

As shown in FIG. 1E, solder paste is spread into the opening 122 of the mask layer 120 to form a solder paste layer 124 (only one is shown) in a printing process. The solder paste layer 124 covers the under-bump-metallurgy layer 112a.

As shown in FIG. 1F, the solder paste 124 is heated to the melting temperature in a reflow process so that a spherical bump 126 is formed.

As shown in FIG. 1G, the mask layer 120 is removed and then another reflow process is conducted to complete the formation of the bump 126. The bump 126 consists of the under-bump-metallurgy layer 112a and the solder material 124.

In the aforementioned bump-forming process, the solder paste layer 124 is made of a mixture of solder powder and flux. In the reflow process of FIG. 1F, the flux within the solder paste 124 will react with the polymer layer 108 to produce water and carbon dioxide or other gases. During the subsequent reflow process, gases including water and carbon dioxide inside the bump 126 will form air bubbles. In the presence of air bubbles, the mechanical strength of the bumps 126 will be weakened, thus leading to a reduced reliability.

Furthermore, the mask layer 120 typically is removed by etching with an etchant. The etchant not only etches away the mask layer 120, but also attach the polymer layer 108 underneath the mask layer 120, so that a portion of the polymer layer 108 will be removed or damaged. Any damage of the polymer layer 108 is likely to compromise the protective capacity on the wafer 100.

### SUMMARY OF INVENTION

Accordingly, one object of the present invention is to provide a bump-forming process capable of reducing bubbles inside the bumps to ensure greater reliability.

A second object of this invention is to provide a bump-forming process capable of preventing the etchant for etching a mask layer from damaging a polymer layer underneath the mask layer so that integrity of the polymer layer is maintained.

To achieve these and other advantages and in accordance with the purpose of the invention, as embodied and broadly described herein, the invention provides a bump-forming process for fabricating bumps over a wafer. The wafer has an active surface with a passivation layer, a polymer layer and a plurality of bonding pads thereon. The passivation layer and the polymer layer have a plurality of first openings that exposes the bonding pads. To fabricate the bumps, an adhesion layer is formed on the active surface of the wafer covering the bonding pads and the polymer layer. Thereafter, a barrier layer and a wettable layer are sequentially formed over the adhesion layer. A portion of the wettable layer and the barrier layer are removed so that the residual wettable and the residual barrier layer remain at least on top of the first openings. Next, a patterned mask layer is formed over the adhesion layer. The patterned mask layer has a plurality of second openings that at least exposes the wettable layer. A printing process is carried out to form a solder paste layer inside the second openings. A reflow process is subsequently performed to transform the solder paste layer into bumps. After removing the mask layer, the adhesion layer outside the residual wettable layer and the residual barrier layer is removed. Another reflow process for treating the bumps can be carried out after removing the adhesion layer outside the residual wettable layer and the residual barrier layer.

The adhesion layer can be fabricated using a material including titanium or aluminum, the barrier layer can be fabricated using a material including nickel-vanadium alloy and the wettable layer can be fabricated using a material including copper, for example.

If the bonding pads are made of aluminum, the under-bump-metallurgy layer is a composite stack that includes an aluminum layer, a nickel-vanadium alloy layer and a copper layer. On the other hand, if the bonding pads are made of copper, the under-bump-metallurgy layer is a composite stack that includes a titanium layer, a nickel-vanadium alloy layer and a copper layer.

In the bump-forming process of this invention, the adhesion layer over the polymer layer is retained before the reflow process. Hence, the polymer layer and the solder paste layer are separated from each other through the adhesion layer during the reflow process. With this arrangement, the flux material inside the solder paste layer is prevented from reacting with the polymer layer and thus reliability of the bumps is ensured.

Furthermore, the adhesion layer over the polymer layer is retained before removing the mask layer. Hence, the adhesion layer over the polymer layer is able to prevent the etching solution for removing the mask layer from damaging the polymer layer. In other words, integrity of the polymer layer can be maintained.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1G are magnified cross-sectional views of the bump sections of a wafer showing the steps for producing a bump according to a conventional method.

FIGS. 2A to 2H are magnified cross-sectional views of the bump sections of a wafer showing the steps for producing a bump according to one preferred embodiment of this invention.

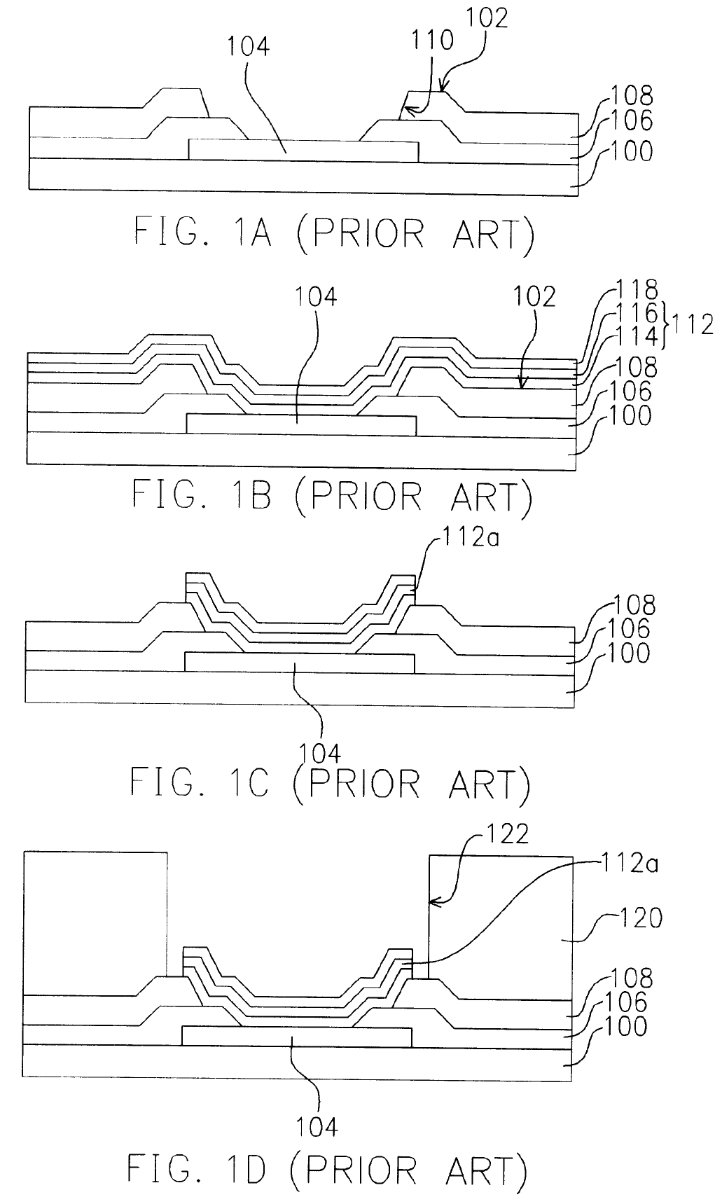

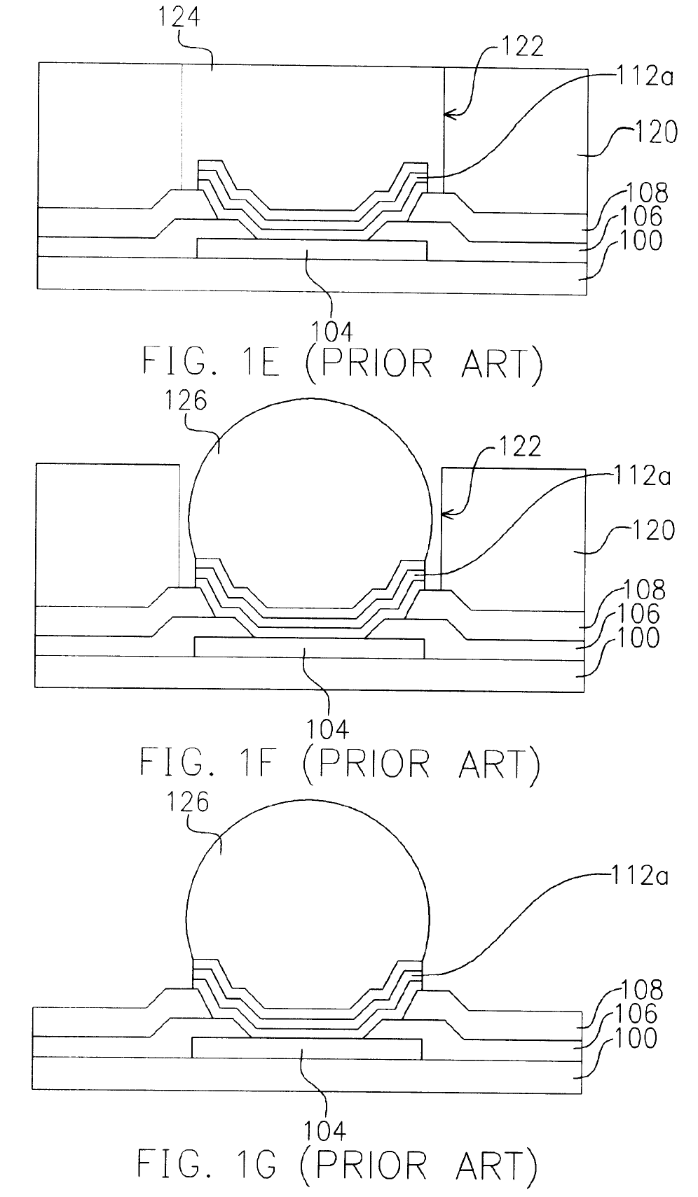

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

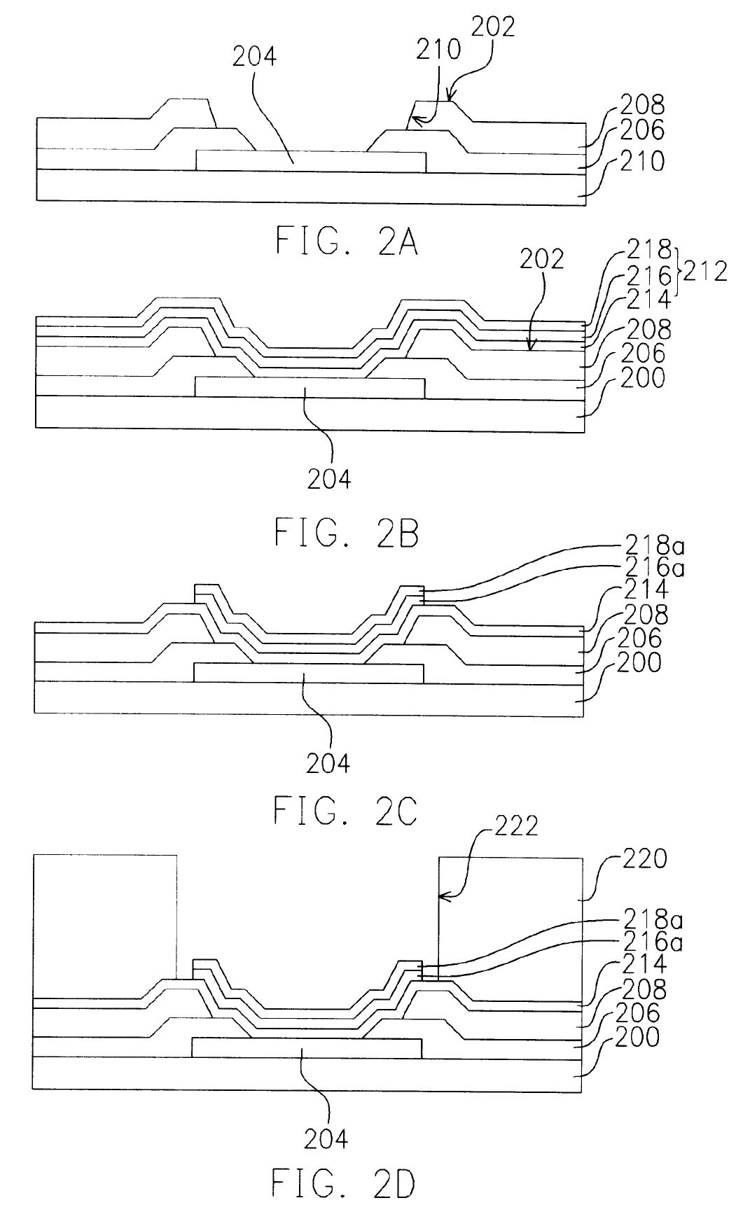

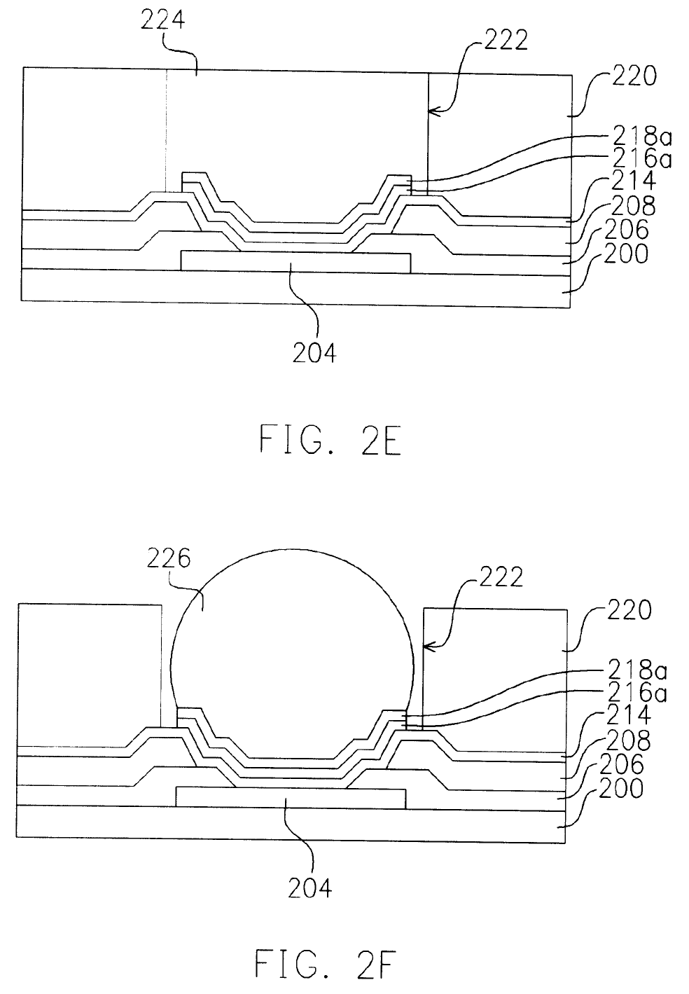

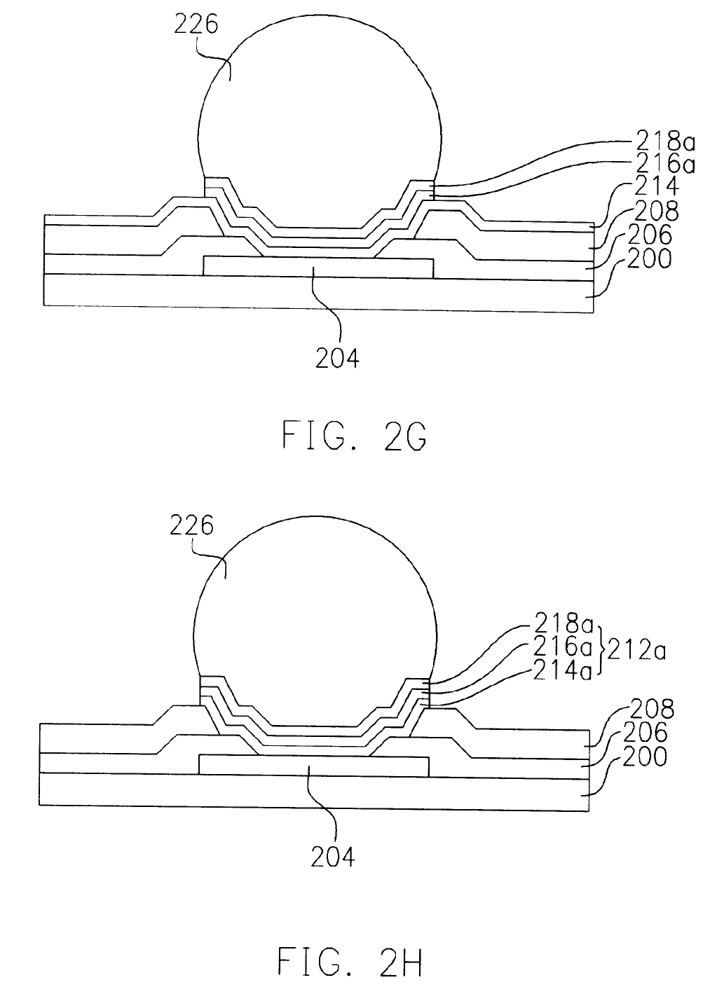

FIGS. 2A to 2H are magnified cross-sectional views of the bump sections of the wafer showing the steps for producing a bump according to one preferred embodiment of this invention. First, as shown in FIG. 2A, a wafer 200 having an active surface 202 with a plurality of bonding pads 204 (only one is shown), a passivation layer 206 and a polymer layer 208 thereon is provided. The passivation layer 206 and the polymer layer 208 are sequentially positioned over the active surface 202, and the passivation layer 206 and the polymer layer 208 include openings 210 that expose the bonding pads 204. The passivation layer 206 is fabricated using a material including, for example, silicon nitride. The polymer layer 208 is fabricated using a material including, for example, benzocyclobutene (BCB) or polyimide (PI). The bonding pads 204 are fabricated using a metallic material including aluminum or copper, for example.

As shown in FIG. 2B, an adhesion layer 214 is formed over the active surface 202 of the wafer 200. The adhesion layer 214 covers the bonding pads 204 and the polymer layer 208. The adhesion layer 214 is fabricated using a metallic layer including, for example, a titanium, aluminum or tantalum. The process of forming the adhesion layer 214 over the waver 200 includes, for example, sputtering or evaporation. Thereafter, a barrier layer 216 is formed on the adhesion layer 214. The barrier layer 216 is fabricated using a material including, for example, nickel-vanadium alloy, titanium nitride compounds, tantalum nitride compounds or nickel. The process of forming the barrier layer 216 includes, for example, sputtering, electroplating or evaporation. Next, a wettable layer 218 is formed on the barrier layer 216. The wettable layer is fabricated using a material including, for example, copper. Similarly, the process of forming the wettable layer includes, for example, sputtering, electroplating or evaporation. The adhesion layer 214, the barrier layer 216 and the wettable layer 218 together form an under-bump-metallurgy layer 212.

In the embodiment of this invention, if the bonding pads 204 are made of aluminum, the adhesion layer 214, the barrier layer 216 and the wettable layer 218 stack structure constituting the under-bump-metallurgy layer 212 is preferably an aluminum/nickel vanadium alloy/copper composite layer. On the other hand, if the bonding pads 204 are made of copper, the adhesion layer 214, the barrier layer 216 and the wettable layer 218 stack structure constituting the under-bump-metallurgy layer 212 is preferably a titanium/nickel vanadium alloy/copper composite layer.

As shown in FIG. 2C, a portion of the wettable layer 218 and a portion of the barrier layer 216 are removed to form the wettable layer 218a and the barrier layer 216a and expose the adhesion layer 214. The wettable layer 218a and the barrier layer 216a at least cover the opening 210. The wettable layer 218 and the barrier layer 216 can be removed, for example, by forming a patterned photoresist layer (not shown) over the wettable layer 218 to serve as an etching mask, etching the exposed wettable layer 218 and the exposed barrier layer 216 and finally removing the photoresist layer. The etchant for etching the copper wettable layer 218 includes, for example, a mixture of ammonium hydroxide and hydrogen peroxide, a mixture of potassium sulfate (K₂SO4) and glycerol or some other known chemical solvents. In addition, the etchant for etching the nickel-vanadium barrier layer 216 includes, for example, sulfuric acid (H₂SO4) or diluted phosphoric acid.

As shown in FIG. 2D, a patterned mask layer 220 is formed on the adhesion layer 214. The mask layer 220 has a plurality of openings 222 (only one is shown) that exposes the wettable layer 218a above the bonding pad 204 and a portion of the adhesion layer 214. The mask layer 220 is fabricated using photoresist, for example. The process of forming the mask layer 220 includes forming a mask layer (not shown) over the wettable layer 218a and the adhesion layer 214 and then forming the openings 222 in the mask layer through operations including photo-exposure and chemical development.

As shown in FIG. 2E, solder paste is deposited into the openings 222 in the mask layer 220 to form a solder paste layer 224. The solder paste comprises, for example, solder powder and flux, with the solder powder fabricated from a metallic material including, for example, gold, lead-tin alloy or lead-free metal. Solder paste is deposited into the openings 222 in the mask layer 220, for example, by printing.

As shown in FIG. 2F, a reflow operation is carried out by heating the solder paste layer 224 to the melting point and hence the solder paste layer 224 in each opening 222 is transformed into a bump 226 having a spherical profile. In the reflow process, since the adhesion layer 214 remains on the polymer layer 208, the flux within the solder paste layer 224 is prevented from reacting with the polymer layer 208 to form air bubbles.

As shown in FIG. 2G, the mask layer 220 over the adhesion layer 214 is removed using an etching solution. Because the adhesion layer 214 is still on the polymer layer 208, the etching solution for removing the mask layer 220 is prevented from damaging the polymer layer 208. Hence, integrity of the polymer layer 208 is preserved.

As shown in FIG. 2H, the exposed adhesion layer 214 is removed. The residual adhesion layer 214 underneath the barrier layer 216a forms an adhesion layer 214a. In the meantime, the polymer layer 208 above the wafer 200 is exposed. The adhesion layer 214 is removed, for example, by using an etchant. The etchant incapable of reacting with the bump 226 is usually selected, in order to prevent reaction with the solder material in a subsequent reflow process. Finally, another reflow process is carried out to complete an integral bump 226 structure.

In this invention, the number of layers constituting the under-bump-metallurgy layer need not be limited to three (the adhesion layer, the barrier layer and the wettable layer). The number of conductive layers in the under-bump-metallurgy layer can be four including, for example, a chromium/chromium copper alloy/copper/silver composite layer. Alternatively, the number of conductive layers in the under-bump-metallurgy layer can be two, including a lower layer such as a titanium alloy layer or a titanium layer and an upper layer such as a copper layer, a nickel layer or a gold layer, for example.

When the under-bump-metallurgy layer 212 is etched in FIG. 2C, etching need not stop at the surface of the adhesion layer 214. The etching process may stop at any metallic layer (the adhesion layer or the barrier layer) other than the wettable layer as long as the etchant is incapable of reacting with subsequently formed bumps, so that the layer for protecting the underlying polymer layer is retained. In general, the under-bump-metallurgy layer can be regarded as consisting of a second under-bump-metallurgy layer that includes the wettable layer and a first under-bump-metallurgy layer that excludes the wettable layer.

In addition, the bumps are not restricted to be formed on the active surface of a wafer. It is also possible to form the bumps on a redistribution layer after the redistribution layer is formed over a wafer. Since the process of forming the redistribution layer is familiar, detail description of the process is omitted.

In summary, this invention includes at least the following advantages: 1. The adhesion layer for protecting the underlying polymer layer is retained before the reflow process so that the polymer layer and the solder paste layer are separated from each other and hence prevents any reaction between the flux within the solder paste and the polymer layer. Thus, reliability of the bumps is improved. 2. Similarly, the adhesion layer over the polymer layer is able to protect the polymer layer against any damaging effect caused by the etching solution in the process of removing the mask layer. Ultimately, integrity of the polymer layer can be maintained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A process for forming a plurality of bumps on a wafer with an active surface, wherein the wafer further includes a passivation layer, a polymer layer and a plurality of bonding pads over the active surface, and the bonding pads are exposed by a plurality of first openings in the passivation layer and the polymer layer, the process comprising the steps of:
forming an adhesion layer over the active surface of the wafer covering the bonding pads and the polymer layer;
forming a barrier layer on the adhesion layer;
forming a wettable layer on the barrier layer;
removing a portion of the wettable layer and a portion of the barrier layer such that the residual wettable layer and the residual barrier layer remain on the bonding pads;
forming a patterned mask layer on the adhesion layer, wherein the mask layer has a plurality of second openings that at least exposes the wettable layer;
performing a printing process to form a solder paste layer inside the second openings by depositing solder paste into each second opening;
performing a first reflow process to transform the solder paste layer inside each second opening into a bump;
removing the patterned mask layer; and
removing the adhesion layer outside the residual wettable and the residual barrier layer.

2. The process of claim 1, wherein after removing the adhesion layer outside the residual wettable layer and the residual barrier layer, the process further includes performing a second reflow process to treat the bumps.

3. The process of claim 1, wherein the adhesion layer is made of a material selected from the group consisting of titanium and aluminum.

4. The process of claim 1, wherein the step of removing the adhesion layer comprises using an etching solution for etching the adhesion layer.

5. The process of claim 4, wherein the etching solution for removing the adhesion layer does not react with the bumps.

6. The process of claim 1, wherein a material of the barrier layer comprises nickel-vanadium alloy.

7. The process of claim 1, wherein a material of the wettable layer comprises copper.

8. The process of claim 1, wherein the polymer layer is made of a material selected from the group consisting of benzocyclobutene (BCB) and polyimide (PI).

9. The process of claim 1, wherein the bonding pads are made of a material selected from the group consisting of copper and aluminum.

10. The process of claim 9, wherein the under-bump-metallurgy layer is an aluminum/nickel-vanadium alloy/copper composite layer when the bonding pads are made of aluminum.

11. The process of claim 9, wherein the under-bump-metallurgy layer is a titanium/nickel-vanadium alloy/copper composite layer when the bonding pads are made of copper.

12. The process of claim 1, wherein the solder paste layer is made of a mixture that includes solder powder and flux.

13. A process of fabricating bumps on an active surface of a wafer, comprising the steps of:
forming a first under-bump-metallurgy layer on the active surface of the wafer;
forming a second under-bump-metallurgy layer on the first under-bump-metallurgy layer;
removing a portion of the second under-bump-metallurgy layer;
forming a patterned mask layer over the first under-bump-metallurgy layer, wherein the mask layer has a plurality of openings that at least exposes the second under-bump-metallurgy layer;
performing a printing process to deposit a solder paste layer into the openings;
performing a first reflow process to transform the solder paste layer inside the openings into bumps;
removing the first under-bump-metallurgy layer outside the residual second under-bump-metallurgy layer; and
performing a second reflow process to treat the bumps.

14. The process of claim 13, wherein the second under-bump-metallurgy layer at least comprises a wettable layer.

15. The process of claim 14, wherein a material of the wettable layer comprises copper.

16. The process of claim 14, wherein the step of forming a second under-bump-metallurgy layer on the first under-bump-metallurgy layer further includes the steps of:
forming a barrier layer on the first under-bump-metallurgy layer; and
forming the wettable layer on the barrier layer.

17. The process of claim 16, wherein a material of the barrier layer includes nickel-vanadium alloy.

18. The process of claim 13, wherein the first under-bump-metallurgy layer includes an adhesion layer.

19. The process of claim 18, wherein the adhesion layer is made of a material selected from the group consisting of titanium and aluminum.

20. The process of claim 19, wherein the step of removing the adhesion layer includes using an etching solution for removing the adhesion layer.

21. The process of claim 18, wherein the etching solution for removing the adhesion layer does not react with the bumps.

22. The process of claim 13, wherein the solder paste layer is made of a mixture that includes solder powder and flux.
